(19) United States
(12) Patent Application Publication
(10) Pub. No.: US 2014/0111379 A1
(43) Pub. Date: Apr. 24, 2014

(54) POSITION-DETERMINING SYSTEM AND METHOD FOR THE OPERATION THEREOF

(71) Applicant: DFORSCHUNGSZENTRUM JUELICH GMBH, Juelich (DE)

(72) Inventors: Jakob Schelten, Juelich (DE); Kari Sobotta, Niederzler (DE); Ralf Engels, Huertgenwald (DE); Christian Mueller, Juelich (DE)

(73) Assignee: FORSCHUNGSZENTRUM JUELICH GMBH, Juelich (DE)

(21) Appl. No.: 14/119,336

(22) PCT Filed: May 4, 2012
(86) PCT No.: PCT/DE2012/000469

§ 371 Date: Dec. 11, 2013

(30) Foreign Application Priority Data
Jul. 14, 2011 (DE) 10 2011 107 333.0

(51) Int. Cl. G01S 5/04

(52) U.S. Cl. CPC G01S 5/04
USPC 342/385

(57) ABSTRACT

A system for determining position comprises at least one transmitter connected to the object, at least two stationary receivers, and means for determining the phase difference with which the signal of the transmitter arrives at the two receivers. Compared to conventional radio direction finding (decca direction finding), transmission takes place only at the location of the mobile object. This has the effect that only one transmitter having very small dimensions and very low power consumption is required at the location of the mobile object. At least one pair of two stationary receivers is used for operation to determine at least one space coordinate of the object position, the measuring region for the object position being located between these receivers at this space coordinate. The position can be determined with high accuracy if the three space coordinates thereof are determined separately using at least one dedicated receiver pair.

### PRIOR ART

Before satellite navigation became the standard, hyperbolic navigation (decca direction finding) was the most accurate navigation aid available close to shore. This system included transmitters having different frequencies installed on land. The signals of different transmitters were superimposed on each other on board a ship or plane. Since the lines having identical phase positions are hyperbolas, the superimposition of the signals of two transmitters supplied the information that the ship or plane had to be located on a particular hyperbola. If the superimposition of a second transmitter pair was also measured, information that the ship or plane had to be located at the intersecting point of two hyperbolas was obtained. The exact position was fixed at the latest with the aid of the superimposition of a third transmitter pair.

The drawback is that this system is too imprecise for smaller distances as small as the laboratory scale, and the required reception devices are difficult to miniaturize,

### PROBLEM AND SOLUTION

Therefore, it is the object of the invention to make a positioning system available, which allows a mobile object to be located with higher accuracy than the hyperbolic navigation according to the prior art for distances as small as the laboratory scale. It is another object of the invention to allow the unit to be carried by the mobile object to be better miniaturized.

These objects are achieved according to the invention by a positioning system according to the main claim and by a method for operation according to the additional independent claim. Further advantageous embodiments will be apparent from the respective dependent claims.

### SUBJECT MATTER OF THE INVENTION

As part of the invention, a positioning system for locating a mobile object was developed. According to the invention, this system comprises at least one transmitter connected to the object, at least two stationary receivers, and means for determining the phase difference with which the signal of the transmitter arrives at the two receivers.

The terms “transmitter” and “receiver” within the meaning of the present invention relate to the capability of emitting or recording electromagnetic waves, including radio signals and light.

Contrary to the known hyperbolic navigation (decca position finding), no superimposition of the signals of two transmitters takes place at the location of the mobile object. Instead, transmission takes place only at the location of the mobile object, and the measurement of the phase difference is shifted to the receiver end. This has the effect that only one transmitter having very small dimensions and very low power consumption is required at the location of the mobile object. For example, such a transmitter can be integrated into a golf dub and/or into a golf ball, without appreciably influencing the dynamics of the stroke. Because the position of the transmitter is continually recorded by the system according to the invention, the correct implementation of the stroke can be checked and errors can be identified, it is also possible to record the fast shaking movements of patients with Parkinson's disease, without the need for damping these by way of a large mass of the transmitter.

The fact that transmission only takes place at the location of the mobile object further has the effect that operation is possible using only one frequency. With the known hyperbolic navigation, the transmitters, the signals of which were superimposed at the location of the mobile object, had to operate with differing frequencies so as to allow the signals to be distinguished from each other. These frequencies had to be multiplied with different integral factors to arrive at a lowest common multiple at the location of the mobile object with the corresponding apparatus-related complexity so as to be able to determine the phase difference. Only one allocation by the authorities is necessary since only one frequency is required according to the invention. Moreover, any arbitrary number of further stationary receivers may be employed to increase the accuracy, without necessitating additional devices at the location of the mobile object.

This becomes especially relevant in a particularly advantageous embodiment of the invention. In this embodiment, the system comprises at least two stationary receivers for each space coordinate of the object position to be determined, wherein the measuring region for the object position at this space coordinate is located between the two receivers.

It was found that, in a Cartesian coordinate system in which the connecting line between two stationary receivers is located on one of the axes, only the coordinate on this axis, or one that is parallel thereto, can be determined with high accuracy. The phase difference results from the difference of the paths that the signal travels from the transmitter to the two receivers. This difference predominantly depends on the space coordinate along the connecting line between the receivers; if the object is moved along this connecting line, the distance from one receiver decreases to the same degree that the distance from the other receiver increases. If therefore, as part of the measuring accuracy, a given phase difference between the signals arriving at the two receivers is measured, the uncertainty regarding the movement along the connecting line that may be responsible for this is small. The invention takes advantage of this fact by creating at least one respective connecting line between two stationary receivers in all the spatial directions in which the position of the mobile object is to be determined. Each pair of receivers having a connecting line in a spatial direction is then a particularly sensitive measuring instrument for movements of the object in exactly this direction.

This highly anisotropic dependency of the phase shift on the object movement was not utilized with the known hyperbolic navigation. Each transmitter pair, between which the phase position was determined at the location of the mobile object, only supplied the information that the current object position must be located on a particular hyperbola. The object position was determined by determining the intersecting point of several such hyperbolas. An option for overweighting the information regarding certain spatial directions supplied by individual transmitter pairs was not provided for. It would also not have been easy to add this functionality to hyperbolic navigation. For one, hyperbolic navigation was used primarily for navigating on and across seas, so that the transmitter locations were dictated by the existing coasts. Secondly, each further transmitter, in turn, would have required a dedicated frequency, with the boundary condition that corresponding lowest common multiples would have to be found at the location of the mobile object. So the fact that, according to the invention, the space coordinates can be determined independently from each other with maximum sensitivity is one of the consequences of the above-described measure of transmitting only at the location of the mobile object.

In a further particularly advantageous embodiment of the invention, the system comprises at least two pairs of stationary receivers, which is to say at least four receivers, for each space coordinate of the object position.

It was found that the accuracy with which the space coordinate of the object can be determined along the connecting line between the two receivers of a pair decreases as the distance of the object from this connecting line increases. By making multiple pairs available, the position of the object can thus be determined with better accuracy in a larger spatial area.

In addition it was found that foreign objects can interfere with the radio transmission between the transmitter and one or more receivers surrounding the measuring region for the object position. When passing through matter, the velocity of light of the wave emitted by the transmitter is decreased by the refractive index of this matter. This acts in the manner of an optical path extension and changes the phase recorded at the receiver. For example, the player may be located between the transmitter and one or more receivers when tracking a golf club or golf ball. Since at least two receiver pairs are now available for each space coordinate, the values of both pairs can be used to determine the object position. For example, the positions supplied by both pairs can be averaged or arithmetically related to each other in another manner. However, it is also possible to carry out a plausibility check and not take the position supplied by one pair into consideration if it changes suddenly and abruptly.

In one particularly advantageous embodiment of the invention, the transmitter comprises a modulator for modulating the signal onto a carrier signal having a higher frequency. Moreover, the positioning system comprises at least one demodulator for demodulating the signal from the mixture of signal and carrier signal recorded by the receivers. To this end, both amplitude modulation and frequency modulation are possible. The frequencies to be used for the radio link between the transmitter and the receivers are generally predetermined by allocations made by the authorities. In Germany, for example, Official Gazette Order 40/2010 of the Federal Network Agency regulates the use of frequencies for non-specific short-range radio devices (SRD). By providing the option of modulating the signal onto the carrier signal, the frequency of the signal can be selected independently of this allocation purely based on the wavelength that is useful for determining the location. It is possible in particular to vary the spatial measuring region for positioning by varying the signal frequency, without necessitating a new frequency allocation for the radio link between the transmitter and receivers.

In addition, it was found that the propagation of the mixture of signal and carrier signal from the transmitter through matter to the receivers is dependent on laws of nature that apply to the frequency of the carrier signal. These include in particular the absorption coefficient and the refractive index for the passage through matter. The selection among the available frequencies for the carrier signal can thus be such that the propagation conditions are the best for the situation at hand.

In a further advantageous embodiment of the invention, the transmitter is a light source, the intensity of which can be modulated using the frequency of the signal. The positioning system further comprises means for demodulating a signal having this frequency from the light intensity recorded by the receivers. The frequency of the signal can also be freely selected in this case. Compared to radio transmission, optical transmission has the advantage that no frequency allocation is required. However, light in the visible range and in the infrared range can no longer penetrate many materials that only weaken a radio signal and shift the phase thereof.

As part of the invention, a method for operating the positioning system was also developed. According to the invention, at least one first pair of two stationary receivers is used to determine at least one space coordinate of the object position, the measuring region for the object position being located between these receivers at this space coordinate. As described above, the space coordinate at which the connecting line between the receivers of a pair is located is the one that can be measured with the highest sensitivity, with this pair.

In a further particularly advantageous embodiment of the invention, at least one second pair of two further stationary receivers is additionally used, between which the measuring region for the object position is likewise located at the space coordinate to be determined. It is then possible, in particular, to arithmetically relate to each other, and in particular to average, the values for the space coordinate determined by way of both pairs. The positioning accuracy can thus be increased. As described above, this is due to the fact that the accuracy decreases as the distance of the object from the connecting line between the receivers of a pair increases, and foreign objects can interfere with the radio transmission between the transmitter and one or more receivers. As an alternative thereto or in combination therewith, an abrupt change in the object position recorded by only one of the two pairs can be accepted as an indicator for a disrupted radio transmission between the transmitter and this pair. If is then possible, for example, not to take the object position recorded by this pair into consideration and instead utilize the position recorded by the other pair.

In a particularly advantageous embodiment of the invention, the measuring region for the object position is selected so that the phase difference between the receivers of at least one pair is in the interval [π/2−π/3, π/2+π3]. The object position results clearly from the measured phase differences only as long as these differences are within the open interval<π/2−π/2, π/2+π/2>. Instances where this limit is exceeded cannot be detected; position determination becomes incorrect without notice. The limitation to the interval [π/2−π/3, π/2+π/3] improves the positioning accuracy. In addition, this interval provides a useful warning threshold at which counter-measures can be taken before the phase differences also depart from the interval<π/2−π/2, π/2+π/2> and positioning becomes incorrect.

The size of the measuring region is primarily dependent on the wavelength of the radiation emitted by the transmitter. At a frequency around 100 MHz, which equates to a wavelength of 3 meters, the interval [π/2−π/3, π/2+π/3] has a spatial expansion of 1 meter. Thus, advantageously a transmitting frequency between 87.5 and 108 MHz is selected. If no allocation exists for the selected frequency, the signal can be modulated onto a carrier signal having an allocated frequency or transmitted by modulating the intensity of a light source.

In a particularly advantageous embodiment of the invention, power function is minimized using the object position as a variable, the power function including the difference between the sine, or cosine, of the phase difference for a pair calculated from the object position and the measured sine, or cosine, of the phase difference for this pair.

The phase difference with which the signal emitted by the transmitter arrives at the receivers of a pair is most sensitively dependent on the space coordinate along the connecting line between the two receivers. However, it also depends on the further space coordinates of the mobile object. Analogously to the known hyperbolic navigation, the phase difference recorded by a pair, taken by itself, only indicates that the mobile object is located somewhere on the surface of a hyperbofoid. If different receiver pairs are now used for determining different space coordinates, it is possible that some of the pieces of information supplied by these pairs contradict each other, analogously to the solution of an overdetermined system of linear equations. So as to determine the object position with the highest possible accuracy based on this data situation, the criterion for this accuracy is formulated in the power function. For example, this criterion can be the minimum quadratic deviation of the calculated sine or cosine from the measured sine or cosine

In a further advantageous embodiment of the invention, the power function additionally includes an additive penalty component, which increases the further the calculated phase difference is outside the interval [π/2−π3, π/2+π/3]. This reflects the finding that the positioning accuracy in this interval is the highest, and positions outside this interval thus tend to be less credible.

In a first step of the search for the minimum, the space coordinates of the object position are advantageously determined independently of each other by carrying out the optimization, in each case, only with respect to one coordinate and keeping the remaining ones fixed. To this end, the optimization can notably be done for a receiver pair with respect to the space coordinate, the axis of which includes the connecting line between the two receivers or is parallel thereto. As described above, the receiver pair can be used to determine this space coordinate, in particular, with the highest sensitivity. The remaining fixed space coordinates can initially be set to plausible starting values, for example. If the optimization with respect to these coordinates was then done later using the other receiver pairs, the values obtained therefrom can take the place of the starting values. After all the space coordinates have been determined, these space coordinates are advantageously used as starting values for the subsequent iteration of the search for the minimum.

The minimum is advantageously searched using the golden section search technique. In this search technique, the search interval is systematically narrowed by dividing it, in each case, at the golden section. This technique is particularly efficient for unimodal functions, which is to say those that have exactly one minimum in the predetermined interval. Because the objective is to find the position of exactly one mobile object and this object cannot be located in a second position at the same time, there is exactly one object position to be found in the measuring region, so that the power function is unimodal.

For example, the positioning system can be used as an experimentation device in a student laboratory to store meter-long traces with an accuracy of approximately 1 mm. Since the position can be recorded with a repetition rate of approximately 1 kHz, it is also possible to record the time curve of the velocity and of the acceleration with sufficient accuracy by way of differentiation. Using an approximately golf bail-sized transmitter, for example, competitions of the following types can be carried out:

Who attains the highest velocity?

Who achieves the greatest acceleration?

Who achieves the greatest force in boxing punches?

Who can best hold an arm extended in the same position for one minute?

Who turns the fastest on a piano stool?

Who preserves the angular momentum on the piano stool most impressively?

Who walks best along a circle that is not drawn but only imaginary?

It is also possible to record the kinetics of standard physical experiments with high accuracy, for example:

the free fail of various bodies differing from each other in terms of the atmospheric friction thereof;

the acceleration with which the end of a heavy chain hanging down moves toward the ground;

inclined plane;

torsion pendulum as an ideal pendulum;

thread pendulum, in particular the non-linearity thereof during larger deflections;

rubber pendulum;

water wave experiments, wherein the transmitter floats on the water;

Newton's law (force=mass*acceleration);

frictional force when a sphere descends in a viscous liquid according to Stokes' law;

billiard strikes;

bounces of a rubber bouncer ball;

tracking players and a ball on a soccer field, in particular in offside or goal positions.

### SPECIFIC DESCRIPTION

The subject matter of the invention will be described hereafter based on FIGS., without thereby limiting the subject matter of the invention. In the drawings:

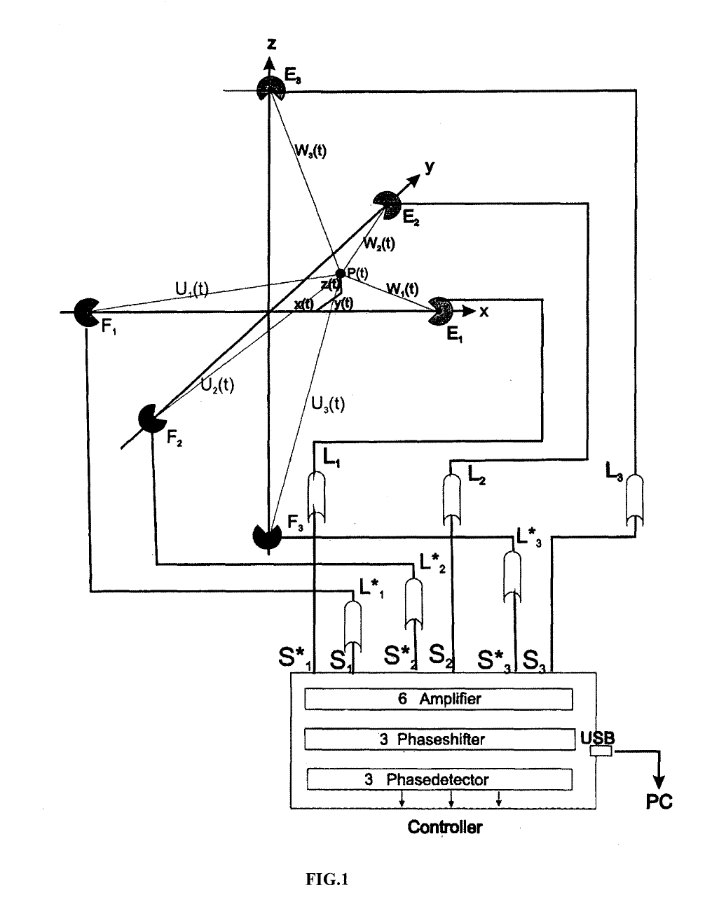

FIG. 1: shows an exemplary embodiment of the positioning system on a laboratory scale;

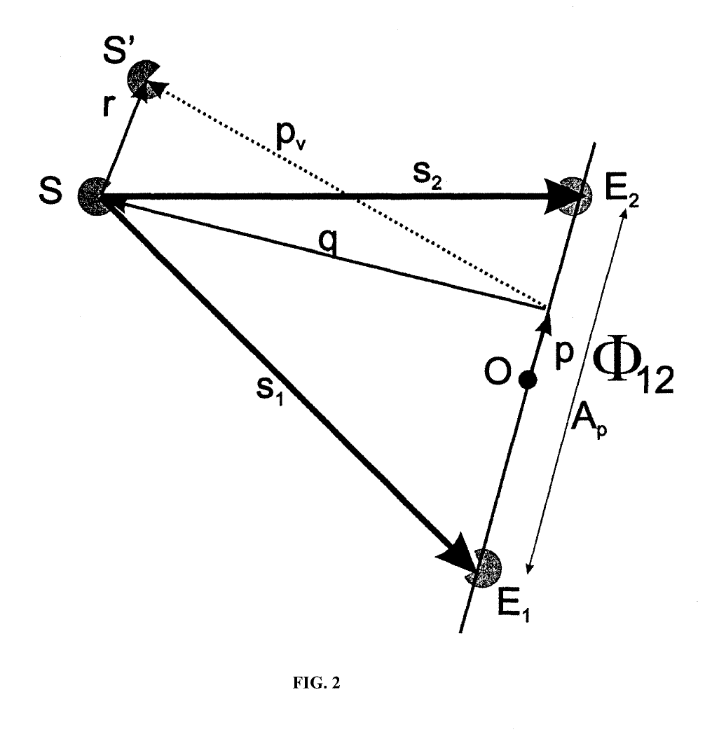

FIG. 2: shows a sketch of the positioning system for error computation;

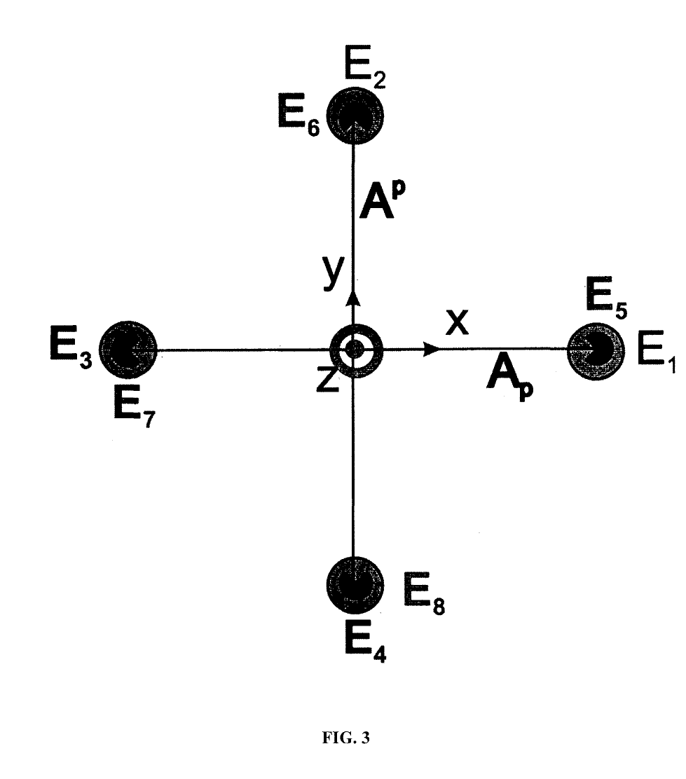

FIG. 3: shows an exemplary embodiment of the positioning system for three-dimensional localization; and

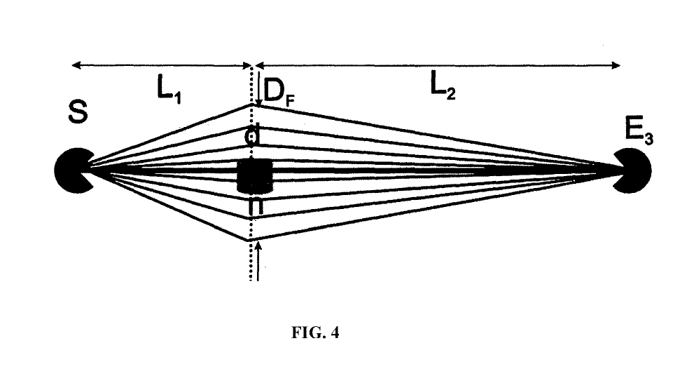

FIG. 4: shows a beam path between a transmitter and a receiver for discussing the influence of matter on signal transmission.

FIG. 1 shows an exemplary embodiment of a positioning system according to the invention on a laboratory scale. The transmitter is located at location P(t) (black dot). It is surrounded by six permanently installed receivers Eᵢ and Fᵢ (in each case, i=1, 2 and 3) symbolized by ¾ circles. These are located at distances Wᵢ(t) and Uᵢ(t) from the location P(t), where i=1, 2 and 3. The receivers are passive RF components, which are connected to the controller by antenna cables Lᵢ and L*ᵢ (in each case, i=1, 2 and 3). There, the signals are amplified by 6 amplifiers (“amplifier”), the phases thereof are shifted in pairs by three phase shifters (“phaseshifter”), and then the phase difference of three pairs is measured by a total of three phase detectors (“phasedetector”). For i=1, 2 and 3, the receivers Eᵢ and Fᵢ form a respective pair, which supplies signals Sᵢ and S*ᵢ to the controller. In the PC, the location P(t), which is to say the coordinates x(t), y(t) and z(t) thereof, are determined relative to a zero position.

FIG. 2 shows the sketch of a positioning system according to the invention, based on which the positioning accuracy and measuring error will be described hereafter. The position of a transmitter S is to be determined by way of two receivers E₁ and E₂ which are located at distances s₁ and s₂, respectively, from the unknown position of the transmitter. A rectangular coordinate system is placed around the origin O in the center of the connecting line between E₁ and E₂. In this system, the unknown position of the transmitter S has the coordinates p parallel to the connecting line between E₁ and E₂; q perpendicular to this connecting line and r protruding perpendicularly from the drawing plane. The distance between E₁ and E₂ is denoted by Aₚ. The transmitter S emits an unmodulated carrier wave having a frequency of 100 MHz (wavelength 3 meters).

The phase difference at which this wave reaches the two receivers E₁ and E₂ is measured and is denoted hereafter by Φ₁₂. It is uniquely defined by the difference in the paths between the transmitter and receivers as long as it is within the open interval<π/2−π/2, π/2+π/2>. So as to achieve high accuracy in determining the location of the transmitter, the interval of the phase difference is further limited to the interval [π/2−π/3, π/2+π/3] in this exemplary embodiment.

The phase difference of interest is given by

$${Φ}_{12} = \frac{2 π}{λ} ( {s}_{2} - {s}_{1} ) + {Φ}_{0} \qquad ( 1 )$$

To this end, Φ₀ is a freely available, additional term.

Equation (1) applies unchanged if the signal has been modulated onto a carrier signal prior to transmission to the receivers and demodulated from this mixture again after reception. The wavelength of the signal then continues to be λ; the wavelength λτ of the carrier signal does not play a role. The same applies if the intensity of a light source as the transmitter is modulated with the frequency of the signal.

The distances s₁ and s₂ are given by (2) and (3).

$$\begin{matrix}{s}_{1} = \sqrt{{( p - \frac{{A}_{p}}{2} )}^{2} + {q}^{2} + {r}^{2}} & ( 2 ) \\ {s}_{2} = \sqrt{{( p + \frac{{A}_{p}}{2} )}^{2} + {q}^{2} + {r}^{2}} & ( 3 )\end{matrix}$$

The objective is to determine the coordinates of the transmitter as accurately as possible from phase differences. A phase detector is not used to directly measure the phase difference F₁₂, but only cos(Φ₁₂). The measuring accuracy δΦ₁₂ is closely tied to the measuring δc accuracy of cos(Φ₁₂).

The possible accuracy for the three coordinates can be inferred from the δc accuracy using the equations (1), (2) and (3), because:

$$\begin{matrix}δ c = δ cos ( {Φ}_{12} ) = ( - sin ( {Φ}_{12} ) δ {Φ}_{12} = ( - sin ( {Φ}_{12} ) \frac{2 π}{λ} ( δ {s}_{2} - δ {s}_{1} ) \\ and & ( 4 ) \\ δ c = ( - sin ( {Φ}_{12} ) \frac{2 π}{λ} ( \frac{\partial ( {s}_{2} - {s}_{1} )}{\partial p} δ p + \frac{\partial ( {s}_{2} - {s}_{1} )}{\partial q} δ q + \frac{\partial ( {s}_{2} - {s}_{1} )}{\partial r} δ r ) & ( 5 )\end{matrix}$$

It is apparent from FIG. 2 that the difference in the distance changes drastically with a change of p since the one distance increases while the other decreases. The circumstances are different for the coordinate q. Here, both distances s₁ and s₂ decrease when q increases, which is to say the phase difference barely changes with q. The circumstances are quite similar for the third coordinate r.

Thus, the first term in (5) is dominant in the first large bracket, and the two others are small. This can be used to learn that only the coordinate p can be measured with high accuracy in the direction of the connecting line between E₁ and E₂. The measuring error δp thereof is;

$$δ p = \frac{1}{2 π} \frac{λ}{\vert ( - sin ( {Φ}_{12} ) \frac{\partial ( {s}_{2} - {s}_{1} )}{\partial p} \vert} δ c \qquad ( 6 )$$

If the transmitter is located between E₁ and E₂, the change in the path difference is at the maximum: the differential quotient then has the value 2. If the phase difference, which should be in the interval [π/2−π/3, π/2+π/3], is then also exactly π/2, one obtains:

$$δ {p}_{min} = \frac{λ}{2 π} \frac{1}{2} δ c \qquad ( 7 )$$

With λ=3 m and δc=0.001, one obtains δpₘᵢₙ=0.25 mm.

When it is ensured that the phase difference remains in the indicated interval, then sin(Φ₁₂) changes in the boundaries between 0.5 and 1.

For the general case where the transmitter is located, relative to the receiver center O, at the location (p, q, r), the measuring error for coordinate p is;

$$δ p \leq 2 \frac{\frac{λ}{2 π} δ c}{\frac{p + {A}_{p} / 2}{\sqrt{{( p + {A}_{p} / 2 )}^{2} + {q}^{2} + {r}^{2}}} - \frac{p - {A}_{p} / 2}{\sqrt{{( p - {A}_{p} / 2 )}^{2} + {q}^{2} + {r}^{2}}}} \qquad ( 8 )$$

In the equation, q and r occur only in the quadratic sum q²+r², which hereafter is denoted by pᵥ² (pᵥ is shown in FIG. 1), and embodies the distance of the transmitter from the connecting line between E₁ and E₂. The measuring error is thus limited by:

$$δ p \leq 2 \frac{\frac{λ}{2 π} δ c}{\frac{p + {A}_{p} / 2}{\sqrt{{( p + {A}_{p} / 2 )}^{2} + {p}_{v}^{2}}} - \frac{p - {A}_{p} / 2}{\sqrt{{( p - {A}_{p} / 2 )}^{2} + {p}_{v}^{2}}}} \qquad ( 9 )$$

If the transmitter is located in the plane of symmetry, then p=0, In this case, the measuring accuracy is simply

$$δ p \leq \sqrt{1 + 4 {( {p}_{v} / {A}_{p} )}^{2}} \frac{λ}{2 π} δ c \qquad ( 10 )$$

At a distance pᵥ, which is five times as large as the transmitter distance Aₚ, the measuring error is

$$δ p \leq \sqrt{1 + 4 \times {5}^{2}} \frac{λ}{2 π} δ c = 5 \frac{λ}{π} = 5 mm \qquad ( 11 )$$

and thus is 10 times greater than the smallest possible error. From this it follows that the measuring accuracy of a coordinate decreases as the distance from the connecting axis increases. Consequently, the accuracy can be increased by using more than one receiver pair for measuring a coordinate.

The determination of the location becomes completely incorrect when the phase difference is outside the interval<π/2−π/2, π/2+π/2>, and it becomes imprecise when the phase difference is outside [π/2−π/3, π/2+π/3]. It is not possible to perceive an instance where the first limit is exceeded, but certainly when the second limit is exceeded.

The boundary lines are given by the edge curves as defined by

$$\vert {Φ}_{12} - {Φ}_{0} \vert = \frac{2 π}{λ} \vert {s}_{2} - {s}_{1} \vert = \frac{π}{3}$$

Using (2) and (3)

$$\vert \sqrt{{( p + \frac{{A}_{p}}{2} )}^{2} + {p}_{v}^{2}} - \sqrt{{( p - \frac{{A}_{p}}{2} )}^{2} + {p}_{v}^{2}} \vert = \frac{1}{2} \frac{λ}{3} \qquad ( 13 )$$

If the transmitter is moving along the connecting axis, which is to say when pᵥ is equal to zero, the bounds are close together, which is to say p=¼λ/3. Note that, (13) describes hyperboioids of revolution having the focal points Aₚ/2 and −Aₚ/2 and having the path difference λ/6. The freedom of movement within the measuring region predetermined by the maximum phase difference thus increases the further the transmitter S is located away from the connecting line between E₁ and E₂. Since it also follows from (11) that the measuring accuracy decreases as the distance pᵥ from the connecting axis increases, a high measuring accuracy and a large freedom of movement are contradicting objectives.

The inventors drew the teaching from the above analysis of using three receiver pairs for determining the three coordinates (x, y, z) of the transmitter, the connecting lines of the pairs pointing in the x, y and z directions. As a result, in each case the receiver pair allowing the most sensitive measurement is used for determining the individual coordinates. In total, more information can thus be measured than is mathematically necessary for positioning. Some of these pieces of information may contradict each other, as is the case with an overdetermined system of linear equations. So as to arrive at the least contradictory positioning of the transmitter S, the position is determined iteratively. This means that, initially, plausible starting values are used for all the coordinates. The coordinates x, y and z are then consecutively optimized, while the two remaining coordinates remain fixed. Thereafter, the process is continued with the optimization of x, and then of y and finally z. This process is repeated until a predetermined termination condition has been reached.

FIG. 3 shows the sketch of a further exemplary embodiment of the positioning system according to the invention, which is intended for the three-dimensional localization of a mobile object within a laboratory. It includes eight receivers E₁ to E₈. The receivers E₁ to E₄ are suspended from the laboratory ceiling, and the receivers E₅ to E₈ are each positioned lower by the same height h. The distances between the receivers and the height h are advantageously selected so that the space circumscribed by the receivers covers as precisely as possible the region in which movements are to be expected. The position of the mobile object in this region can then be determined with the highest possible accuracy. Two receiver pairs (E₁ with E₃ and E₅ with E₇) are available for measuring the x coordinate, likewise two receiver pairs (E₂ with E₄ and E₆ with E₈) are available for measuring the y coordinate, and four receiver pairs (E₁ with E₅, E₂ with E₆, E₃ with E₇, and E₄ with E₈) are available for measuring the z coordinate.

The following describes how the three coordinates x, y and z are determined iteratively.

A location P₀ having the coordinates (x₀, y₀, z₀) is established, at which the phase differences of all pairs are set to π/2. The coordinate system is established by the connecting directions of the pairs, and they are denoted by x, y and z in FIG. 2. In the defined coordinate system, the receivers have exactly determined coordinates, for example the receiver E₁ has the triplet (xE₁, yE₁, zE₁). The transmitter P has the coordinates (x(t), y(t), z(t)), which change overtime.

The distances from the receiver E₁ to the transmitter, at the location P, are denoted by s₁(P), or by s₁(P₀) when the transmitter is located at the location P₀. The following applies:

s₁(P)={square root over ((x(t)−xE₁)²+(y(t)−yE₁)²+z(t)−zE₁)²)} (15)

This designation specifies the phase difference between the receiver pair, for example Eᵢ and Eₖ, after scaling by way of:

$${φ}_{i k} ( P ) = \frac{π}{2} + \frac{2 π}{λ} \{ [ {s}_{k} ( P ) - {s}_{i} ( P ) ] - [ {s}_{k} ( {P}_{0} ) - {s}_{i} ( {P}_{0} ] \} \qquad ( 16 )$$

The phase detector, which compares the phases of the wave arriving at the two receivers, does not supply the phase difference directly, but the cosine cos(Φᵢₖ^{exp}) thereof. For the test as to the extent to which this value conforms to a transmitter position P at the assumed coordinates (x, y, z). Φᵢₖ(P) from (16) is expressed as a function of the coordinates x, y and z by inserting the terms (15). Based on the difference of the two cosines, the following power function is set up, the minimum of which is to be found;

$$Min ! Δ ( x , y , z ) = \{ \begin{matrix}{[ cos ( {φ}_{ik} ( P ) ) - cos ( {φ}_{ik}^{exp} ) ]}^{2} + \\ w {( {φ}_{ik} ( P ) - \frac{π}{6} )}_{+}^{2} + {w ( 5 \frac{π}{6} - {φ}_{ik} ( P ) )}_{+}^{2}\end{matrix} \} \qquad ( 17 )$$

The minimization is carried out so that two variables at a time remain fixed, while the third is varied for minimizing. The minimization does not relate only to the difference between the desired value and the actual value for the cosine of the phase difference, but also fakes into consideration that, in the interest of as high a measuring accuracy as is possible, only the interval π/6<Φᵢₖ(P)<5π/6 is to be used as the measuring region. When this measuring region is exceeded, the values of the two additive penalty components in (17), which are each weighed using a factor w, increase.

The definition used in the penalty function was that

$${x}_{+}^{2} = \{ \begin{matrix}{x}^{2} & x > 0 \\ 0 & otherwise\end{matrix} \} \qquad ( 18 )$$

This function is continuously differentiable, the second derivative is discontinuous at x=0.

For the minimum search, the golden section search technique is employed in the form of the “golden” routine described in the book “Numerical Recipes in C” (W.H. Press et al., Cambridge University Press). This routine only requires bracketing of the minimum; this bracketing can be obtained from the boundary values that the transmitter is located directly at one of the two receivers.

The following method using at least three receiver pairs, the straight connecting lines of which point in the x, y and z directions, successively carries out a minimization of the first pair with respect to x, then one of the second pair with respect to y, and finally one of the third pair with respect to z. Thereafter, the next iteration starts again with the minimization with respect to x, wherein y and z are maintained fixed at the previously determined values. If the position (xₘᵢₙ, yₘᵢₙ, zₘᵢₙ) no longer changes during the iterations, the solution is self-consistent and is accepted as the result for the transmitter position.

One should still check whether the objective function at the minimum is close to zero and that the values of the penalty function at the minimum are small.

The influence of various positioning interferences will be described hereafter,

1. Passage of the Signal Through Matter

The phase of the radio frequency at one of the receivers is changed when matter enters the beam path of the RF wave between the transmitter and receiver. This is because, in matter, the propagation velocity of an RF wave is no longer the speed of light in vacuum c, but only c/n. Here, n is the refractive index of the material for the frequency that is used, it is n=∈^{1/2} and ∈ is the relative permittivity. For fat and bones, ∈=10 at a frequency of 100 MHz, and thus the refractive index n=3.16. For muscle mass, ∈=100 at the same frequency, and thus n=10.

If an RF wave penetrates a wail having a cross-section of ∞ in size, a thickness d and a refractive index n, the phase at the receiver changes by the value Δφ

$$Δ ϕ = \frac{2 π}{λ} ( n - 1 ) d \qquad ( 20 )$$

as compared to before, without the wall. Equation (20) requires that the interfering object has an infinitely large cross-section, something which almost never applies in practical experience.

If the signal was modulated onto a carrier signal having a higher frequency prior to the transmission from the transmitter to the receiver, equation (20) continues to apply to the phase shift of the signal. However, the refractive index of the matter at the frequency of the carrier signal is to be used for n.

When the positioning system according to the invention is used on a laboratory scale, a case that is frequently encountered is that a finger, a hand, the head or the upper body enters the beam path between the transmitter and receiver.

A rough estimation may be obtained via the influence of smaller objects in the beam using the Huygens' principle during diffraction, which leads to the Fresnel zones.

FIG. 4 shows the beam path between the transmitter S and the receiver E₃. The figure shows those beams illustrated which are located within the first Fresnel zone having the diameter D_{F}. A cubic interfering object having the edge length d and refractive index n is located in the beam path, wherein d<<D_{F}.

The diameter of the first Fresnel zone is

D_{F}=2\sqrt{λL₁₂} (21)

with the definition

$$\frac{1}{{L}_{12}} = \frac{1}{{L}_{1}} + \frac{1}{{L}_{2}} \qquad ( 22 )$$

L₁₂<L₁ and <L₂ applies. At L₁₂=1 m, D_{F}=3.4 m. Beams at the edge of the first Fresnel zone have a path difference of λ/2 compared to the central beam.

The phase change that occurs then has a magnitude of

$$Δ ϕ = {( \frac{d}{{D}_{F}} )}^{2} 2 π ( n - 1 ) \frac{d}{λ} \qquad ( 23 )$$

or when using (21) and (22), one obtains

$$Δ ϕ = \frac{π}{2} ( n - 1 ) d ( \frac{1}{{L}_{1}} + \frac{1}{{L}_{2}} ) {( \frac{d}{λ} )}^{2} \qquad ( 24 )$$

According to this, Δφ grows proportionally to d³ and inversely to λ².

If the signal was modulated onto a carrier signal having the wavelength λ_{T} prior to transmission from the transmitter to the receivers, equation (24) becomes

$$Δ ϕ = \frac{{d}^{3}}{{λ}_{T} λ {L}_{12}} \frac{π}{2} ( n - 1 ) \qquad ( 24 a )$$

where n is again the refractive index of the matter for the carrier signal.

A few numerical examples convey the impression of the power of the effect:

1. Example: d=10 cm (fist) n=3 L₁=1 m L₂>>L₁ λ=3 m: ΔΦ=0.3 mrad.

2. Example: d=30 cm (head) n=3 L₁=0.5 m L₂>>L₁ λ=3 m: ΔΦ=9.5 mrad,

3. Example: d=10 cm (fist) n=3 L₁=0.1 m L₂>>L₁ λ=3 m: ΔΦ=0.3 mrad.

The examples demonstrate that some of the phase changes are above the measuring limit of ˜1.5 mrad. If the signal was modulated onto a carrier signal having a higher frequency, the denominator in equation (24a) becomes smaller and the phase difference becomes considerably larger.

2. Reflected Radiation

The details regarding the reflection behavior of electromagnetic radiation will be described using the Fresnel formulas. At the air-dielectric boundary crossing, only a small portion is reflected with perpendicular incidence, and considerably more is reflected with grazing incidence. With perpendicular polarization, the reflected beam is phase-shifted by π compared to the incident beam. For determination of the position, changes of the fractions of reflected radiation which are measured in the receiver may have a distorting effect in terms of the phase and amplitudes.

The influences of this error source can be minimized, for example, by way of shielding, absorption and directional antennas.

3. Absorption

Absorption denotes a weakening of the received signal. This is inconsequential because the signals are scaled during the phase detection.

4. Diffuse Scattering

Because the wavelength is large compared to almost all the dimensions in the space, scattering takes place without any directional preference, and the fraction of radiation arriving at the receiver by way of diffuse scattering is too small to have any influence on the phase of the directly received radiation.

1. A positioning system for locating a mobile object, comprising at least one transmitter connected to the object, at least two stationary receivers, and means for determining the phase difference with which the signal of the transmitter arrives at the two receivers.

2. The positioning system according to claim 1, comprising at least two stationary receivers for each space coordinate of the object position to be determined, wherein the measuring region for the object position at this space coordinate is located between the two receivers.

3. The positioning system according to claim 2, comprising at least two pairs of stationary receivers for each space coordinate of the object position.

4. The positioning system according to claim 1, wherein the transmitter comprises a modulator for modulating the signal onto a carrier signal having a higher frequency, the positioning system comprising at least one demodulator for demodulating the signal from the mixture of signal and carrier signal recorded by the receivers.

5. The positioning system according to claim 1, wherein the transmitter is a light source, the intensity of which can be modulated with the frequency of the signal, the positioning system comprising means for demodulating a signal having this frequency from the light intensity recorded by the receivers.

6. The method for operating a positioning system according to claim 2, wherein at least one first pair of two stationary receivers is used to determine at least one space coordinate of the object position, the measuring region for the object position being located between these receivers at this space coordinate.

7. The method according to claim 6, wherein at least one second pair of two further stationary receivers is additionally used, between which the measuring region for the object position is likewise located at the space coordinate to be determined.

8. The method according to claim 7, wherein the values for the space coordinate which were determined by way of both pairs are arithmetically related to each other, and in particular are averaged.

9. The method according to claim 7, wherein an abrupt change in the object position recorded by only one of the two pairs is accepted as an indicator for a disrupted radio transmission between the transmitter and this pair.

10. The method according to claim 6, wherein the measuring region for the object position is selected so that the phase difference between the receivers of at least one pair is in the interval [π/2−π/3, π/2+3].

11. The method according to claim 6, wherein a power function is minimized using the object position as a variable, the power function including the difference of the sine, or cosine, of the phase difference for a pair calculated from the object position and the measured sine, or cosine, of the phase difference for this pair.

12. The method according to claim 11, wherein the power function additionally includes an additive penalty component, which increases the further the calculated phase difference is outside the interval [π/2−π/3, π/2+π/3].

13. The method according to claim 11, wherein the space coordinates of the object, position are determined independently of each other by carrying out the optimization in each case only with respect to one coordinate and keeping the remaining ones fixed.

14. The method according to claim 13, wherein after all space coordinates have been determined, these space coordinates are used as starting values for the following iteration of the minimum search.

15. The method according to claim 11, wherein the minimum of the power function is searched using the golden section search technique.
